(19) United States
(12) Patent Application Publication
(10) Pub. No.: US 2014/0119191 A1
(43) Pub. Date: May 1, 2014

(54) NETWORK MANAGEMENT APPARATUS AND METHOD

(71) Applicant: Fujitsu Limited, Kawasaki-shi (JP)

(72) Inventor: Koichi ONOUE, Kawasaki (JP)

(73) Assignee: Fujitsu Limited, Kawasaki-shi (JP)

(21) Appl. No.: 13/954,262

(22) Filed: Jul. 30, 2013

(30) Foreign Application Priority Data
Oct. 25, 2012 (JP) 2012-235657

(51) Int. Cl. H04L 12/801

(52) U.S. Cl. CPC H04L 47/15
USPC 370/236

(57) ABSTRACT

A disclosed network management method includes: when the number of multicast domains in a network exceeds a predetermined threshold, setting one new multicast domain for at least a part of plural multicast domains based on an inclusion relationship among the plural multicast domains; and transmitting to a relay apparatus, data representing correspondence between a multicast address of the plural multicast domains and a multicast address of the one new multicast domain.

### CROSS-REFERENCE TO RELATED APPLICATIONS

This application is based upon and claims the benefit of priority of the prior Japanese Patent Application No. 2012-235657, filed on Oct. 25, 2012, the entire contents of which are incorporated herein by reference.

### FIELD

This invention relates to a multicast technique.

### BACKGROUND

The multicast is a communication method for transmitting data to nodes that belong to a multicast domain simultaneously.

A method is known that preferentially utilizes the multicast instead of the unicast in order to reduce the communication load on a network when delivering data.

Moreover, a method is known that utilizes the multicast instead of the broadcast in order to reduce the communication load on a network in a data center.

However, the number of multicast routes that a relay apparatus such as a router and switch can process (i.e. the number of multicast addresses) is limited. Therefore, when the multicast domains in the network are generated too much, the multicast addresses are exhausted.

According to the aforementioned background art, when preventing from exhausting the multicast addresses by simply substituting the multicast with the unicast or broadcast, the communication load on the network increases by the unicast or broadcast.

In other words, no conventional art can reduce the communication load on a network in which the number of multicast addresses that can be used is limited.

### SUMMARY

A network management relating to this invention method includes: upon detecting that the number of multicast domains in a network exceeds a predetermined threshold, setting one new multicast domain for at least a part of plural multicast domains based on an inclusion relationship among the plural multicast domains; and transmitting to a relay apparatus, data representing correspondence between a multicast address of the plural multicast domains and a multicast address of the one new multicast domain.

The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### BRIEF DESCRIPTION OF DRAWINGS

FIG. 1 is a diagram depicting an outline of a system in this embodiment of the present invention;

FIG. 2 is a functional block diagram of a topology management apparatus;

FIG. 3 is a functional block diagram of a router;

FIG. 4 is a diagram depicting an example of data stored in a domain data storage unit;

FIG. 5 is a diagram depicting an example of data stored in a device data storage unit;

FIG. 6 is a diagram depicting an example of data stored in a topology data storage unit;

FIG. 7 is a diagram depicting an example of data stored in a data storage unit;

FIG. 8 is a diagram depicting a processing flow of a processing executed by the topology management apparatus and the router;

FIG. 9 is a diagram depicting a processing flow of a setting processing;

FIG. 10 is a diagram depicting an example of data stored in an added address storage unit;

FIG. 11 is a diagram depicting an example of data stored in a route data storage unit;

FIG. 12 is a diagram depicting an example of an inclusion relationship;

FIG. 13 is a diagram depicting an example of an inclusion relationship;

FIG. 14 is a diagram depicting an example of an inclusion relationship;

FIG. 15 is a diagram depicting a processing flow of the setting processing;

FIG. 16 is a diagram depicting an example of an inclusion relationship;

FIG. 17 is a diagram depicting an example of an inclusion relationship;

FIG. 18 is a diagram depicting an example of an inclusion relationship;

FIG. 19 is a diagram depicting an example of an inclusion relationship;

FIG. 20 is a diagram depicting a processing flow of a processing executed when the router receives correspondence data;

FIG. 21 is a diagram depicting a processing flow of a processing executed when the router relays packets;

FIG. 22 is a diagram depicting a specific example of packet transfer;

FIG. 23 is a diagram depicting a specific example of packet transfer;

FIG. 24 is a diagram depicting a specific example of packet transfer;

FIG. 25 is a diagram depicting a specific example of packet transfer;

FIG. 26 is a diagram depicting a specific example of packet transfer;

FIG. 27 is a diagram depicting a specific example of packet transfer;

FIG. 28 is a diagram depicting a specific example of packet transfer;

FIG. 29 is a diagram depicting a specific example of packet transfer;

FIG. 30 is a functional block diagram of a computer; and

FIG. 31 is a functional block diagram of a router when implemented as a computer.

### DESCRIPTION OF EMBODIMENTS

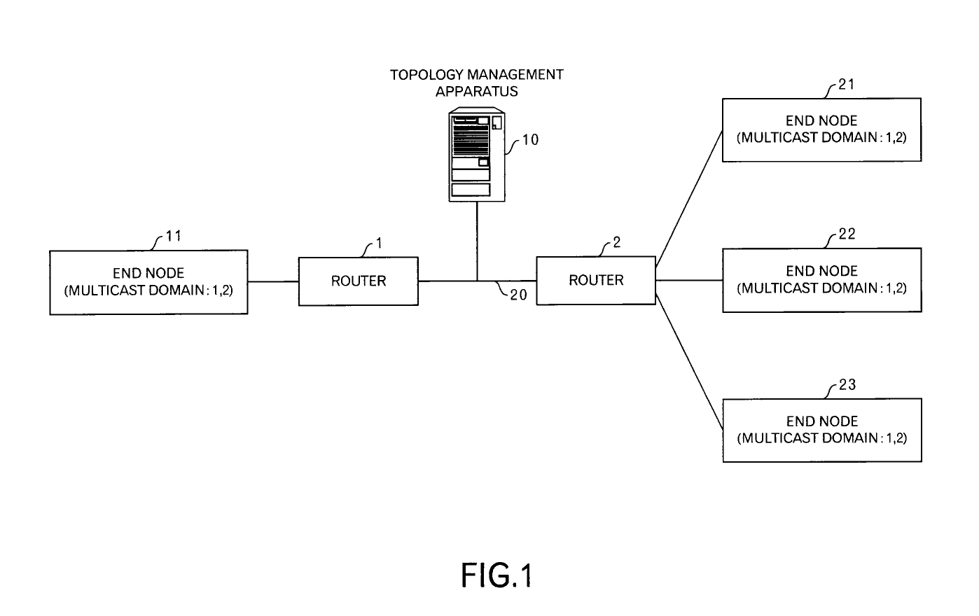

FIG. 1 illustrates an outline of a system in this embodiment. For example, routers 1 and 2 that are physical routers are connected through a network 20. The network 20 is connected with a topology management apparatus 10 that executes a main processing in this embodiment. The topology management apparatus 10 manages a topology of the network 20 in the system illustrated in FIG. 1. The router 1 is connected with an end node 11 that is a node positioned at an end portion of the network 20. The router 2 is connected with end nodes 21 to 23 that are positioned at the end portion of the network 20. The end node 11 and end nodes 21 to 23 belong to multicast domains 1 and 2. Therefore, a packet addressed to the multicast address of the multicast domain 1 or 2 are transferred to the end node 11 and end nodes 21 to 23.

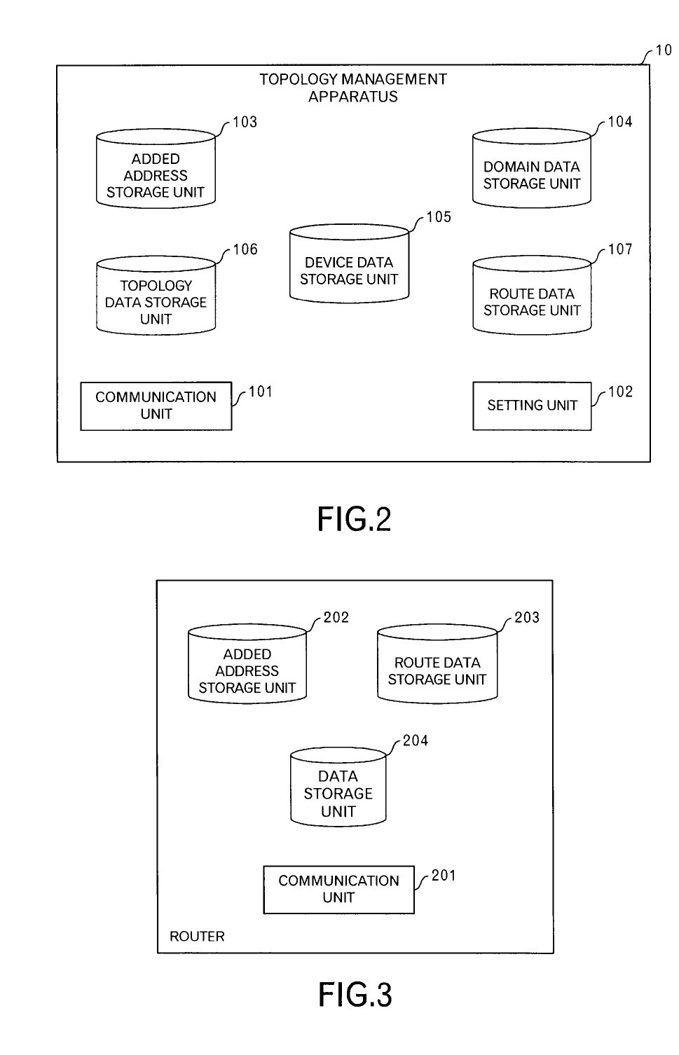

FIG. 2 illustrates a functional block diagram of the topology management apparatus 10. The topology management apparatus 10 includes a communication unit 101, a setting unit 102, an added address storage unit 103, a domain data storage unit 104, a device data storage unit 105, a topology data storage unit 106 and a route data storage unit 107. The communication unit 101 performs a processing to receive or transmit data and the like. The setting unit 102 performs a processing to set a multicast domain and the like.

FIG. 3 illustrates a functional block diagram of the routers 1 and 2. The routers 1 and 2 include a communication unit 201, an added address storage unit 202, a route data storage unit 203 and a data storage unit 204. The communication unit 201 performs a processing to transmit or received data and the like.

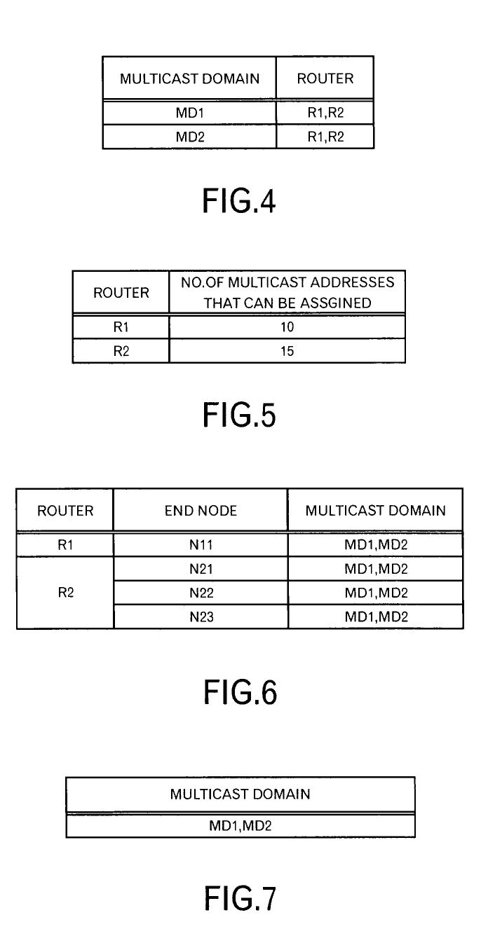

FIG. 4 illustrates an example of data stored in the domain data storage unit 104 in the topology management apparatus 10. In an example of FIG. 4, a multicast address of a multicast domain and an address of a router that is in charge of the routing of the multicast domain are stored.

FIG. 5 illustrates an example of data stored in the device data storage unit 105 of the topology management apparatus 10. In an example of FIG. 5, an address of a router and the number of multicast addresses that can be assigned to the router are stored. The number of multicast addresses that can be assigned to the router is the number of multicast routes that the router can process, and determined based on the specification of the router or the like.

FIG. 6 illustrates an example of the topology data stored in the topology data storage unit 106 of the topology management apparatus 10. In an example of FIG. 6, an address of a router, an address of an end node under the router and a multicast address of a multicast domain for which the router is in charge of the routing are stored.

FIG. 7 illustrates an example of data stored in the data storage unit 204 of the router. In an example of FIG. 7, multicast addresses of a multicast domain for which the router is in charge of the routing are stored.

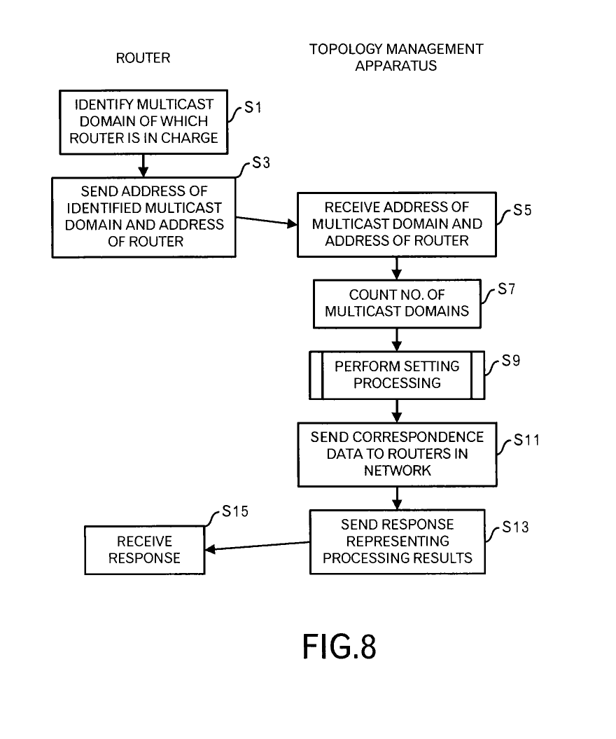

Next, operations of the system illustrated in FIG. 1 will be explained by using FIGS. 8 to 29. First, a processing to set the multicast domain by the topology management apparatus 10 will be explained by using FIGS. 8 to 19.

First, the communication unit 201 of the router (here, the router 1) receives a packet in Internet Group Management Protocol (IGMP) or Protocol Independent Multicast (PIM). Then, the communication unit 201 identifies a multicast domain for which the router 1 is in charge of the routing, by using the data storage unit 204 (FIG. 8: step S1).

The communication unit 201 transmits a multicast address of the multicast domain identified at the step S1 and an address of the router 1 to the topology management apparatus 10 (step S3).

The communication unit 101 of the topology management apparatus 10 receives the multicast address of the multicast domain to which the router 1 belongs and the address of the router 1 from the router 1 (step S5). The setting unit 102 updates data stored in the domain data storage unit 104 by information received at the step S5. However, when the multicast domain for which the router 1 is in charge of the routing does not change, data after the update is the same as data before the update.

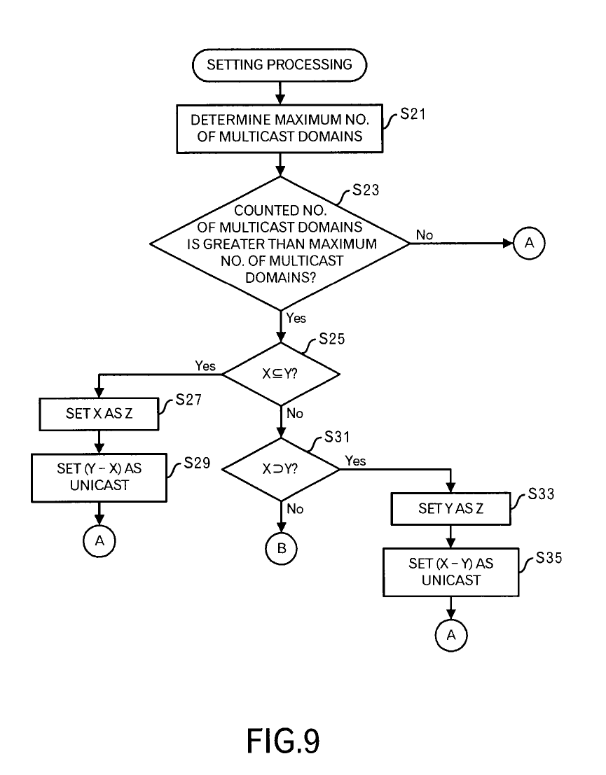

The setting unit 102 counts the number of multicast domains by counting the number of multicast addresses stored in the domain data storage unit 104 (step S7). Then, the setting unit 102 performs a setting processing (step S9). The setting processing will be explained by using FIGS. 9 to 19.

First, the setting unit 102 determines the maximum number of multicast domains in the system illustrated in FIG. 1 by identifying the minimum value of the values stored in the column of the number of multicast addresses that can be assigned to the router in the device data storage unit 105 (FIG. 9: step S21) However, the target router is either of the following candidates.

(A) all routers in the network

(B) routers that are in charge of the routing of the multicast domain to be processed

For example, router A, router B and router C are disposed in the network, and the numbers of multicast domains that can be assigned to the router A, router B and router C are 10, 20 and 30, respectively. In such a case, the maximum number of multicast domains, which is determined according to (A), is “10”. Moreover, for example, when the routers that are in charge of the routing of the multicast domain to be processed are the router B and router C, the maximum number of multicast domains, which is determined according to (B), is “20”.

The multicast domains to be processed are two multicast domains that are selected from among the multicast domains in the network. These two domains are called the multicast domain X and multicast domain Y in the following. The multicast domain X and multicast domain Y are selected in advance by a user using either method in the following or any combination of them.

(a) two multicast domains determined so that the number of end nodes that belong to a new multicast domain Z among end nodes that belong to either of the two multicast domains becomes maximum.

(b) two multicast domains determined so that the number of end nodes that do not belong to a new multicast domain Z among end nodes that belong to either of the two multicast domains becomes minimum.

(c) two multicast domains that are not used recently.

The approach (c) is the same as that of Least Recently Used (LRU) that is a page replacement algorithm.

Returning to the explanation of FIG. 9, the setting unit 102 determines whether or not the number of multicast domains, which was counted at the step S7, is greater than the maximum number of multicast domains (step S23). When the counted number of multicast domains is equal to or less than the maximum number of multicast domains (step S23: No route), the processing returns to a calling-source processing through terminal A. When the counted number of multicast domains is greater than the maximum number of multicast domains (step S23: Yes route), the setting unit 102 determines, based on the topology data stored in the topology data storage unit 106, whether or not X⊂Y is satisfied (step S25). In other words, the setting unit 102 determines whether or not the multicast domain X is included in the multicast domain Y or whether or not the multicast domain X is identical with the multicast domain Y.

In case of X [symbol] Y (step S25: Yes route), the setting unit 102 sets the multicast domain X as one new multicast domain Z (step S27). The setting unit 102 stores setting contents into the added address storage unit 103 and route data storage unit 107.

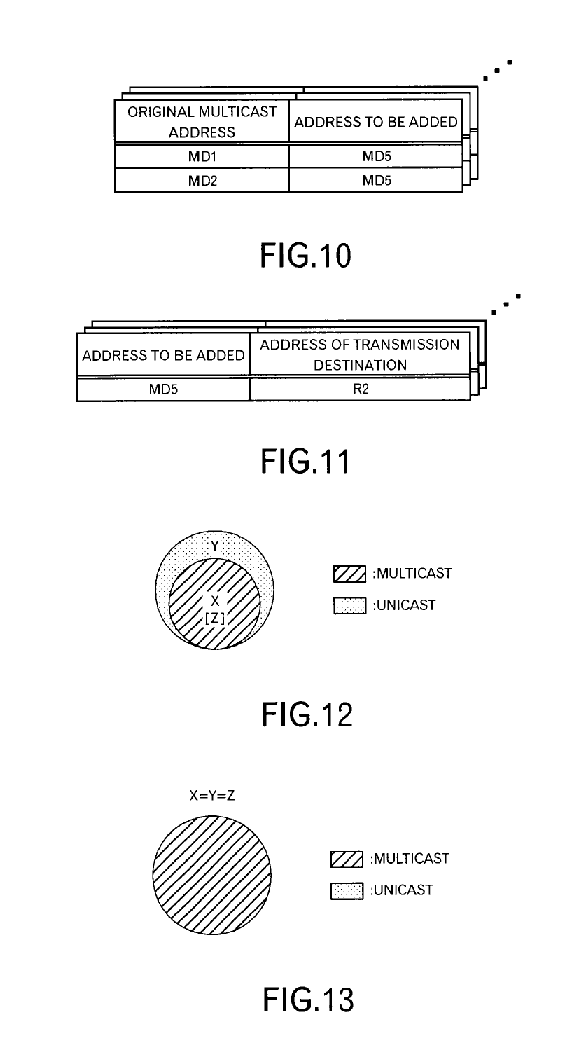

FIG. 10 illustrates an example of data stored in the added address storage unit 103. In an example of FIG. 10, an address of an original multicast domain and an address to be added to a packet are stored. At the step S27, as the setting contents, the setting unit 102 stores the multicast address of the multicast domain X in the column of the “original multicast address” in the added address storage unit 103 and stores the multicast address of the multicast domain Z in the column of the “address to be added”. The multicast address of the multicast domain Z is a multicast address, which is newly assigned (i.e. unused).

Data illustrated in FIG. 10 is generated for each router used for the determination of the maximum number of multicast domains at the step S21.

FIG. 11 illustrates an example of data stored in the route data storage unit 107. In an example of FIG. 11, an address to be added to a packet and address of the transmission destination are stored. At the step S27, as the setting contents, the setting unit 102 stores the multicast address of the multicast domain Z in the column of the “address to be added to packet” in the route data storage unit 107, and stores an address of the transmission destination of the packet in the column of the “address of transmission destination”. The transmission destination is identified based on the topology data stored in the topology data storage unit 106.

Data illustrated in FIG. 11 is generated for each router used for the determination of the maximum number of multicast domains at the step S21.

Returning to the explanation of FIG. 9, the setting unit 102 sets a domain corresponding to (Y-X) as the unicast (step S29). Then, the processing returns to the calling-source processing through the terminal A. As the setting contents, the setting unit 102 stores the multicast address of the multicast domain Y in the column of the “original multicast address” in the added address storage unit 103, and stores the multicast address of the multicast domain Z in the column of the “address to be added”. Moreover, as the setting contents, the setting unit 102 stores the multicast address of the multicast domain Y in the column of the “original multicast address” in the added address storage unit 103, and stores a unicast address of the transmission destination of the packet in the column of the “address to be added”. The transmission destination of the packet is identified based on the topology data stored in the topology data storage unit 106.

FIG. 12 illustrates an example of a case where X and Y satisfy a condition “X⊂Y”. In an example of FIG. 12, the multicast domain X is included in the multicast domain Y, and is set as the multicast domain Z. Therefore, the multicast address of the multicast domain Z is added to a packet for the multicast domain X. Moreover, the multicast address of the multicast domain Z is also added to a packet for a domain corresponding to “X∩Y” among the multicast domain Y. Moreover, the unicast address of the transmission destination of the packet is added to a packet to a domain corresponding to “Y-X”. Thus, by decreasing the number of multicast domains by “1”, the packet for the domain corresponding to “Y-X” is transmitted by the unicast. However, the multicast domain X is set so that the number of end nodes that are targets of the unicast becomes minimum. In other words, the multicast domain Z is set so that the number of end nodes belonging to the multicast domain Z becomes maximum.

FIG. 13 illustrates an example of a case where X and Y satisfy a condition “X=Y”. In an example of FIG. 13, the multicast domain X is identical with the multicast domain Y, and the multicast domain X and the multicast domain Y are set as the multicast domain Z. Therefore, the multicast address of the multicast domain Z is added to a packet for the multicast domain X. Therefore, the multicast address of the multicast domain Z is added to a packet for the multicast domain Y. Thus, in case of X=Y, even when the number of multicast domains is decreased by “1”, there is no packet transmitted by the unicast.

Returning to the explanation of FIG. 9, when X and Y do not satisfy “X [symbol] Y” (step S25: No route), the setting unit 102 determines whether or not a condition “X⊃Y” is satisfied (step S31). In other words, the setting unit 102 determines whether or not the multicast domain X includes the multicast domain Y.

In case of “X⊃Y” (step S31: Yes route), the setting unit 102 sets the multicast domain Y as one new multicast domain Z (step S33). As the setting contents, the setting unit 102 stores the multicast address of the multicast domain Y in the column of the “original multicast address” in the added address storage unit 103, and stores the multicast address of the multicast domain Z in the column of the “address to be added”. The multicast address of the multicast domain Z is a multicast address, which is newly assigned (i.e. unused). Moreover, as the setting contents, the setting unit 102 stores the multicast address of the multicast domain Z in the column of the “address to be added to the packet” in the route data storage unit 107, and stores the address of the transmission destination of the packet in the column of the “address of transmission destination”. The transmission destination of the packet is identified based on the topology data stored in the topology data storage unit 106.

The setting unit 102 sets the domain corresponding to “X-Y” as the unicast (step S35). Then, the processing returns to a calling-source processing through the terminal A. As the setting contents, the setting unit 102 stores the multicast address of the multicast domain X in the column of the “original multicast address” in the added address storage unit 103, and stores the multicast address of the multicast domain Z in the column of the “address to be added”. Moreover, as the setting contents, the setting unit 102 stores the multicast address of the multicast domain X in the column of the “original multicast address” in the added address storage unit 103, and stores the unicast address of the transmission destination of the packet in the column of the “address to be added”. The transmission destination of the packet is identified based on the topology data stored in the topology data storage unit 106.

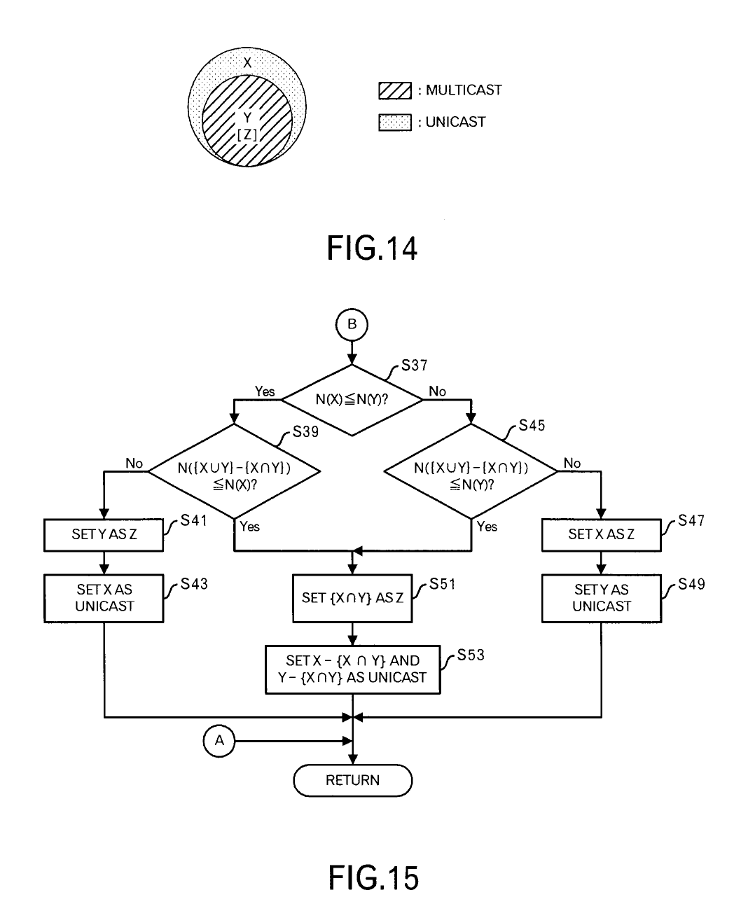

FIG. 14 illustrates an example of a case where X and Y satisfy a condition “X⊃Y”. In an example of FIG. 14, the multicast domain X includes the multicast domain Y, and the multicast domain Y is set as the multicast domain Z. Therefore, the multicast address of the multicast domain Z is added to the packet for the multicast domain Y. Moreover, the multicast address of the multicast domain Z is also added to the packet for a domain corresponding to “X∩Y” among the multicast domain X. Moreover, the unicast address of the transmission destination of the packet is added to the packet for the domain corresponding to “X-Y”. Thus, by decreasing the number of the multicast domains by “1”, and a packet for the domain corresponding to “X-Y” is transmitted by the unicast. However, the multicast domain X is set so that the number of end nodes that are targets of the unicast becomes minimum. In other words, the multicast domain Z is set so that the number of end nodes belonging to the multicast domain Z becomes maximum.

Returning to the explanation of FIG. 9, when X and Y do not satisfy a condition “X⊃Y” (step S31: No route), the processing shifts to step S37 in FIG. 15 through terminal B.

Shifting to explanation of FIG. 15, the setting unit 102 determines whether or not N(X)≦N(Y) is satisfied (step S37). Here, N(m) is the number of end nodes belonging to the multicast domain m.

In case of N(X)≦N(Y) (step S37: Yes route), the setting unit 102 determines whether or not N({X∪Y}−{X∩Y})≦N(X) is satisfied (step S39).

When “N({X∪Y}−{X∩Y})≦N(X)” is not satisfied (step S39: No route), the setting unit 102 sets the multicast domain Y as one new multicast domain Z (step S41). As the setting contents, the setting unit 102 stores the multicast address of the multicast domain Yin the column of the “original multicast address” in the added address storage unit 103, and stores the multicast address of the multicast domain Z in the column of the “address to be added”. The multicast address of the multicast domain Z is a multicast address that is newly assigned (i.e. unused). In addition, as the setting contents, the setting unit 102 stores the multicast address of the multicast domain Z in the column of the “address to be added to packet” in the route data storage unit 107, and stores the address of the transmission destination of the packet in the column of the “address of transmission destination”. The transmission destination of the packet is identified based on the topology data stored in the topology data storage unit 106.

The setting unit 102 sets the multicast domain X as the unicast (step S43). As the setting contents, the setting unit 102 stores the multicast address of the multicast domain X in the column of the “original multicast address” in the added address storage unit 103, and stores the unicast address of the transmission destination of the packet in the column of the “address to be added”. The transmission destination of the packet is identified based on the topology data stored in the topology data storage unit 106.

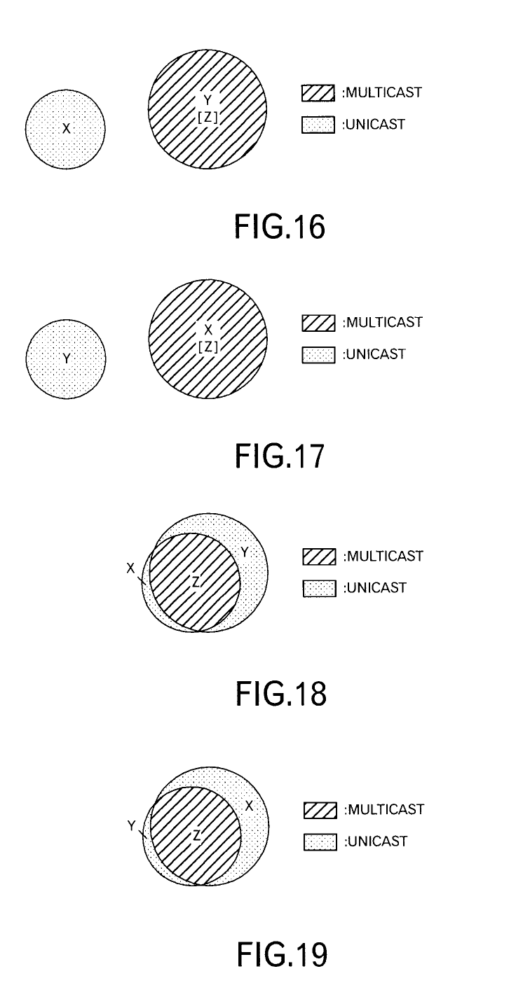

FIG. 16 illustrates an example of a case where X and Y satisfy a condition “N(X)≦N(Y) and N({X∪Y}−{X∩Y})>N(X)”. In an example of FIG. 16, the multicast domain X does not include the multicast domain Y, and the multicast domain Y is set as the multicast domain Z. Therefore, the multicast address of the multicast domain Z is added to a packet for the multicast domain Y. Moreover, the unicast address of the transmission destination of the packet is added to the packet for the multicast domain X. Thus, by decreasing the number of multicast domains by “1”, a packet for the multicast domain X is transmitted by the unicast. However, the multicast domain X is set so that the number of end nodes that are targets of the unicast becomes minimum. Namely, the multicast domain Z is set so that the number of end nodes that belong to the multicast domain Z becomes maximum.

Returning to the explanation of FIG. 15, in case of N(X)>N(Y) (step S37: No route), the setting unit 102 determines whether or not a condition “N({X∪Y}−{X∩Y})≦N(Y)” is satisfied (step S45).

When the condition “N({X∪Y}−{X∩Y})≦N(Y)” is not satisfied (step S45: No route), the setting unit 102 sets the multicast domain X as one new multicast domain Z (step S47). As the setting contents, the setting unit 102 stores the multicast address of the multicast domain X in the column of the “original multicast address” in the added address storage unit 103, and stores the multicast address of the multicast domain Z in the column of the “address to be added”. The multicast address of the multicast domain Z is an address that is newly assigned (i.e. unused). Moreover, as the setting contents, the setting unit 102 stores the multicast address of the multicast domain Z in the column of the “address to be added to packet” in the route data storage unit 107, and stores the address of the transmission destination of the packet in the column of the “address of transmission destination”. The transmission destination of the packet is identified based on the topology data stored in the topology data storage unit 106.

The setting unit 102 sets the multicast domain Y as the unicast (step S49). As the setting contents, the setting unit 102 stores the multicast address of the multicast domain Y in the column of the “original multicast address” in the added address storage unit 103, and stores the unicast address of the transmission destination of the packet in the column of the “address to be added”. The transmission destination of the packet is identified based on the topology data stored in the topology data storage unit 106.

FIG. 17 illustrates an example of a case where X and Y satisfy a condition “N(X)>N(Y) and N({X∪Y}−{X∩Y})>N(Y)”. In an example of FIG. 17, the multicast domain Y is not included in the multicast domain X, and the multicast domain X is set as the multicast domain Z. Therefore, the multicast address of the multicast domain Z is added to a packet for the multicast domain X. Moreover, the unicast address of the transmission destination of the packet is added to a packet for the multicast domain Y. Thus, by decreasing the number of multicast domains by “1”, the packet for the multicast domain Y is transmitted by the unicast. However, the multicast domain X is set so that the number of end nodes that are targets of the unicast becomes minimum. In other words, the multicast domain Z is set so that the number of end nodes that belong to the multicast domain Z becomes maximum.

Returning to the explanation of FIG. 15, when it is determined at the step S39 that a condition “N({X∪Y}−{X∩Y})≦N(X)” is satisfied (step S39: Yes route), or when it is determined at the step S45 that the condition “N({X∪Y}−{X∩Y})≦N(Y)” is satisfied (step S45: Yes route), the setting unit 102 sets a domain corresponding to “{X∩Y}” as one new multicast domain Z (step S51). As the setting contents, the setting unit 102 stores the multicast address of the multicast domain X in the column of the “original multicast address” in the added address storage unit 103, and stores the multicast address of the multicast domain Z in the column of the “address to be added”. The multicast address of the multicast domain Z is a multicast address that is newly assigned (i.e. unused). Moreover, as the setting contents, the setting unit 102 stores the multicast address of the multicast domain Y in the column of the “original multicast address” in the added address storage unit 103, and stores the multicast address of the multicast domain Z in the column of the “address to be added”. Furthermore, as the setting contents, the setting unit 102 stores the multicast address of the multicast domain Z in the column of the “address to be added to packet” in the route data storage unit 107, and stores the address of the transmission destination of the packet in the column of the “address of transmission destination”. The transmission destination of the packet is identified based on the topology data stored in the topology data storage unit 106.

The setting unit 102 sets a domain corresponding to X−{X∩Y} and a domain corresponding to Y−{X∩Y} as the unicast (step S53). As the setting contents, the setting unit 102 stores the multicast address of the multicast domain X in the column of the “original multicast address” in the added address storage unit 103, and stores the unicast address of the transmission destination of the packet in the column of the “address to be added”. Moreover, as the setting contents, the setting unit 102 stores the multicast address of the multicast domain Y in the column of the “original multicast address” in the added address storage unit 103, and stores the unicast address of the transmission destination of the packet in the column of the “address to be added”. The transmission destination of the packet is identified based on the topology data stored in the topology data storage unit 106. Then, the processing returns to the calling-source processing.

FIG. 18 illustrates an example of a case where X and Y satisfy a condition “N(X)<N(Y) and N({X∪Y}−{X∩Y})≦N (X)”. In an example of FIG. 18, a portion of the multicast domain X is included in the multicast domain Y, and a domain corresponding to “X∩Y” is set as the multicast domain Z. Therefore, the multicast address of the multicast domain Z is added to the packet for the domain corresponding to “X∩Y”. Moreover, the unicast address of the transmission destination of the packet is added to a packet for a domain corresponding to “X−{X∩Y}” and a domain corresponding to “Y−{X∩Y}”. Thus, by decreasing the number of multicast domains by “1”, the packet for the domain corresponding to “X−{X∩Y}” and the domain corresponding to “Y−{X∩Y}” is transmitted by the unicast. However, the setting is carried out so that the number of end nodes that are targets of the unicast becomes minimum. In other words, the setting is carried out so that the number of end nodes belonging to the multicast domain Z becomes maximum.

FIG. 19 illustrates an example of a case where X and Y satisfy a condition “N(X)>N(Y) and N({X∪Y}−{X∩Y})≦N(Y)” In an example of FIG. 19, a portion of the multicast domain Y is included in the multicast domain X, and a domain corresponding to “X∩Y” is set as the multicast domain Z. Therefore, the multicast address of the multicast domain Z is added to the packet for the domain corresponding to “X∩Y”. Moreover, the unicast address of the transmission destination of the packet is added to a packet for a domain corresponding to “X−{X∩Y}” and a domain corresponding to “Y−{X∩Y}”. Thus, by decreasing the number of multicast domains by “1”, the packet for the domain corresponding to “X−{X∩Y}” and the domain corresponding to “Y−{X∩Y}” is transmitted by the unicast. However, the setting is carried out so that the number of end nodes that are targets of the unicast becomes minimum. In other words, the setting is carried out that the number of end nodes belonging to the multicast domain Z becomes maximum.

By carrying out the aforementioned processing, it is possible to prevent from exhausting the multicast address in the network in which the number of multicast addresses that can be used is limited and to reduce the communication load on the network. Moreover, because the number of end nodes that belong to a newly set multicast domain becomes maximum, it is possible to efficiently suppress the increase of the communication load on the network.

Returning to the explanation of FIG. 8, the communication unit 101 of the topology management apparatus 10 transmits correspondence data including data stored in the added address storage unit 103 and data stored in the route data storage unit 107 to routers in the network (step S11). When (A) is selected at the step S21, the setting unit 102 transmits the correspondence data to a router (i.e. edge router) connected to the end node. On the other hand, when (B) is selected at the step S21, the setting unit 102 transmits the correspondence data to a router that is in charge of the routing for the multicast domain to be processed. However, when the new multicast domain is not set, the processing of the step S11 is not executed.

For each router, data for that router among the data stored in the added address storage unit 103 and data for that router among the data stored in the route data storage unit 107 are transmitted to that router. Because each router only stores data for that router, the resource of the router, which is required for the data, can be reduced.

The communication unit 101 transmits a response representing a processing result of the setting processing (S9) to the router 1 (step S13). When the multicast domain Z is newly set by the setting processing, the response includes data representing the number of multicast domains is greater than the maximum number of multicast domains. On the other hand, when the multicast domain Z is not newly set, the response includes data representing the number of multicast domains is equal to or less than the maximum number of multicast domains.

The communication unit 201 in the router 1 receives the response from the topology management apparatus 10 (step S15). By doing so, the router 1 can confirm whether or not the processing is completed, normally.

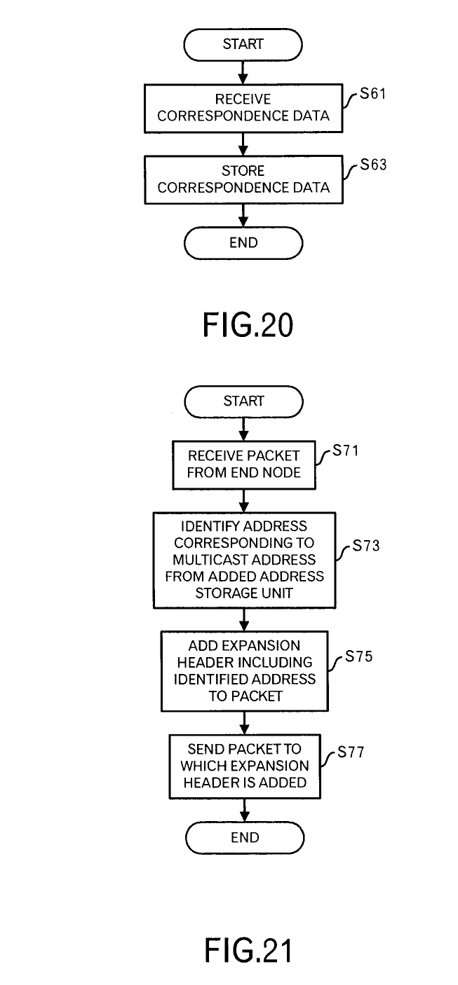

By using FIG. 20, a processing executed when the correspondence data transmitted at the step S11 is received by the router 1 will be explained. The communication unit 201 in the router 1 receives the correspondence data from the topology management apparatus 10 (FIG. 20: step S61).

The communication unit 201 stores data of the added address storage unit 103 in the correspondence data into the added address storage unit 202. Data structure in the added address storage unit 202 is the same as the data structure in the added address storage unit 103 in the topology management apparatus 10. Moreover, the communication unit 201 stores data of the route data storage unit 107 in the correspondence data into the route data storage unit 203 (step S63). Then, the processing completes. Data structure of the route data storage unit 203 is the same as the data structure of the route data storage unit 107.

By carrying out such a processing, the multicast data can be transmitted to the multicast domain Z that was newly set by the topology management apparatus 10. Moreover, the data can be transmitted by the unicast to a node that does not belong to the multicast domain Z, but is an end node belonging to the multicast domain X or Y.

Furthermore, because the new setting of the multicast domain is automatically made while the topology management apparatus 10 and router 1 cooperate, the workload of the network manager can be reduced.

Next, a processing executed when the router relays the packets will be explained by using FIGS. 21 to 29.

First, the communication unit 201 of the router (here, router 1) receives a packet from an end node 11 under the router 1 (FIG. 21: step S71).

The communication unit 201 identifies an address corresponding to the multicast address included in the received packet from the added address storage unit 202 (step S73). When plural addresses are identified at the step S73, the communication unit 201 copies the packet by the number of addresses.

The communication unit 201 adds an expansion header including the address identified at the step S73 to the packet received at the step S71 (step S75). The processing of the step S75 is a processing for encapsulation.

The communication unit 201 transmits the packet to which the expansion header is added to a router of the transmission destination (step S77). Then, the processing ends. When the address included in the expansion header is the unicast address of the router, the transmission destination is the router. When the address included in the expansion header is the multicast address, the address of the transmission destination is identified from the route data storage unit 203, and the packet is transmitted to that transmission destination.

In the following, a specific example of the packet transfer will be illustrated.

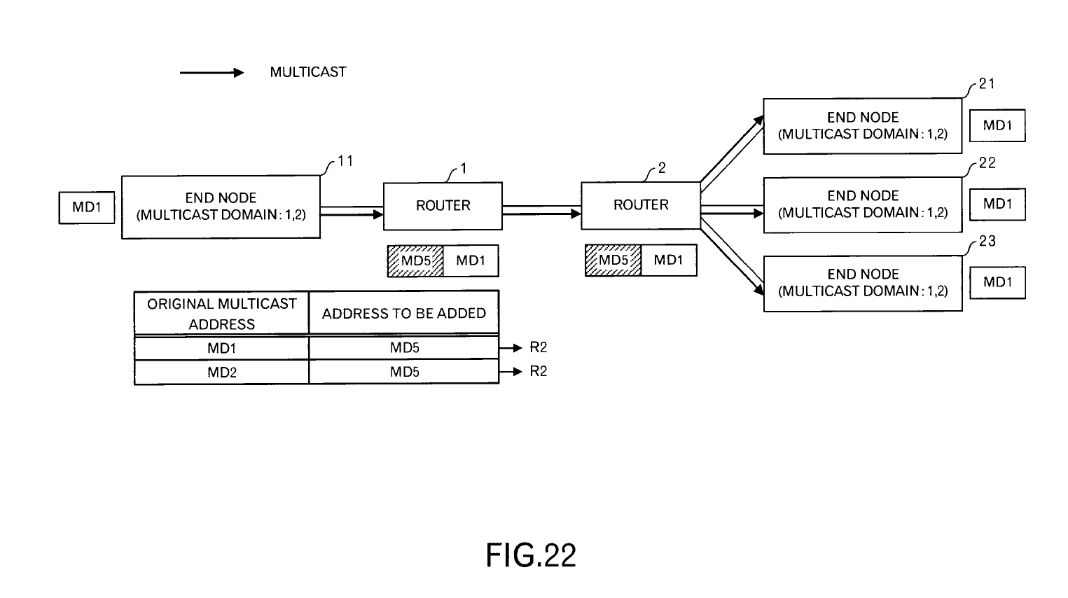

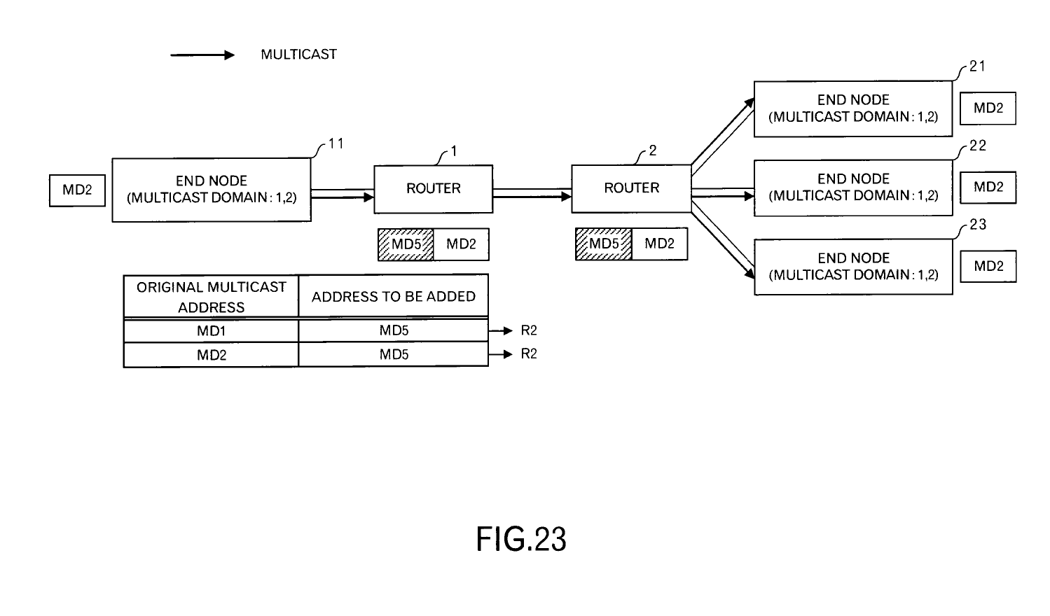

FIGS. 22 and 23 illustrate a packet transfer when the inclusion relationship between two multicast domains is the relationship as illustrated in FIG. 13. FIG. 22 is a diagram illustrating a transfer of a packet including a multicast address “MD1”, and FIG. 23 is a diagram illustrating a transfer of a packet including a multicast address “MD2”. The multicast domain 1 is equal to the multicast domain 2. The router 1 is connected with end node 11 that belongs to the multicast domains 1 and 2. The router 2 is connected to end nodes 21, 22 and 23 that belong to the multicast domains 1 and 2.

When the router 1 receives a packet including the multicast address “MD1” from the end node 11, the router 1 transmits the packet to which the multicast address “MD5” is added to the router 2. When the router 2 receives the packet to which the multicast address “MD5” is added, the router 2 eliminates the multicast address “MD5” from the received packet, and transfers the packet after the elimination to the end nodes 21 to 23.

In case of the multicast address “MD2”, the processing is the same as that of the multicast address “MD1”. When the router 1 receives a packet including the multicast address “MD2” from the end node 11, the router 1 transmits a packet to which the multicast address “MD5” is added to the router 2. When the router 2 receives the packet to which the multicast address “MD5” is added, the router 2 eliminates the multicast address “MD5” from the received packet, and transmits the packet after the elimination to the end nodes 21 to 23.

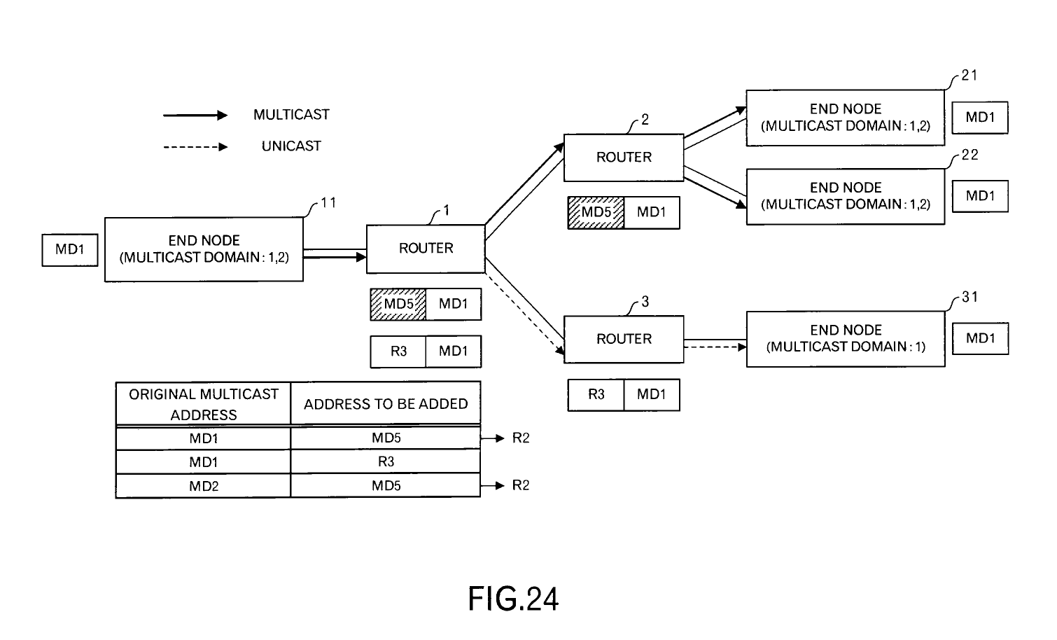

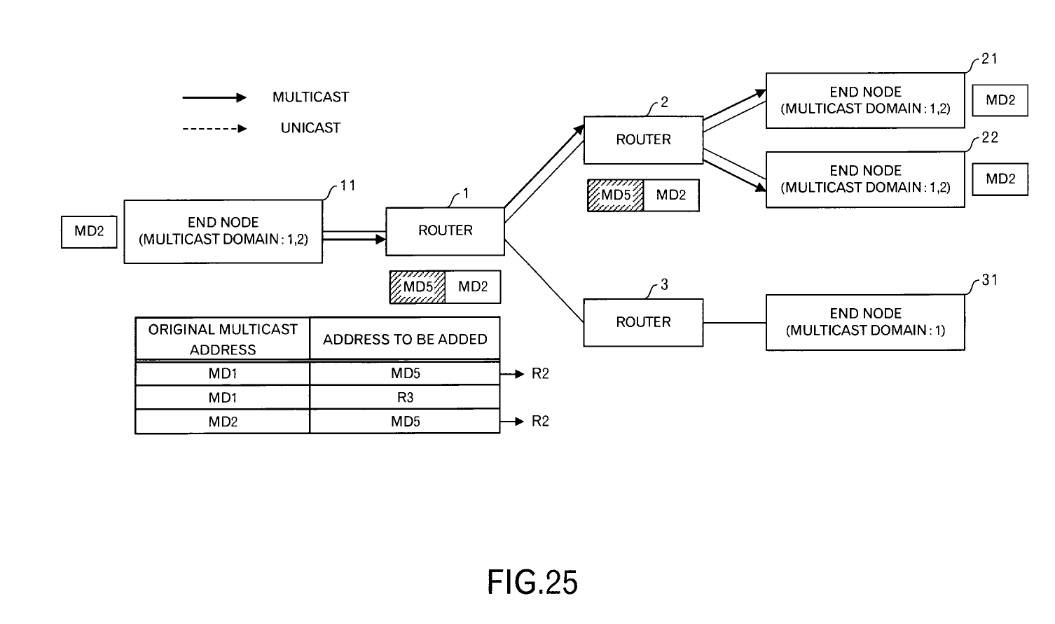

FIGS. 24 and 25 illustrate the packet transfer incase where the inclusion relationship between two multicast domains is the relationship as illustrated in FIG. 12 or FIG. 14. FIG. 24 illustrates the transfer of the packet including the multicast address “MD1”, and FIG. 25 illustrates the transfer of the packet including the multicast address “MD2”. The multicast domain 1 includes the multicast domain 2. The router 1 is connected with the end node 11 that belongs to the multicast domains 1 and 2. The router 2 is connected with the end nodes 21 and 22 that belong to the multicast domains 1 and 2. The router 3 is connected with the end node 31 that belongs to the multicast domain 1.

When the router 1 receives the packet including the multicast address “MD1” from the end node 11, the router 1 generates a packet to which the multicast address “MD5” is added, and transmits the generated packet to the router 2. Moreover, the router 1 generates a packet to which the unicast address “R3” is added, and transmits the generated packet to the router 3. When the router 2 receives a packet to which the multicast address “MD5” is added, the router 2 eliminates the multicast address “MD5” from the received packet, and transmits the packet after the elimination to the end nodes 21 and 22. When the router 3 receives the packet to which the unicast address “R3” is added, the router 3 eliminates the unicast address “R3” from the received packet, and transmits the packet after the elimination to the end node 31.

When the router 1 receives a packet including the multicast address “MD2” from the end node 11, the router 1 generates a packet to which the multicast address “MD5” is added, and transmits the generated packet to the router 2. When the router 2 received the packet to which the multicast address “MD5” is added, the router 2 eliminates the multicast address “MD5” from the received packet, and transmits the packet after the elimination to the end nodes 21 and 22.

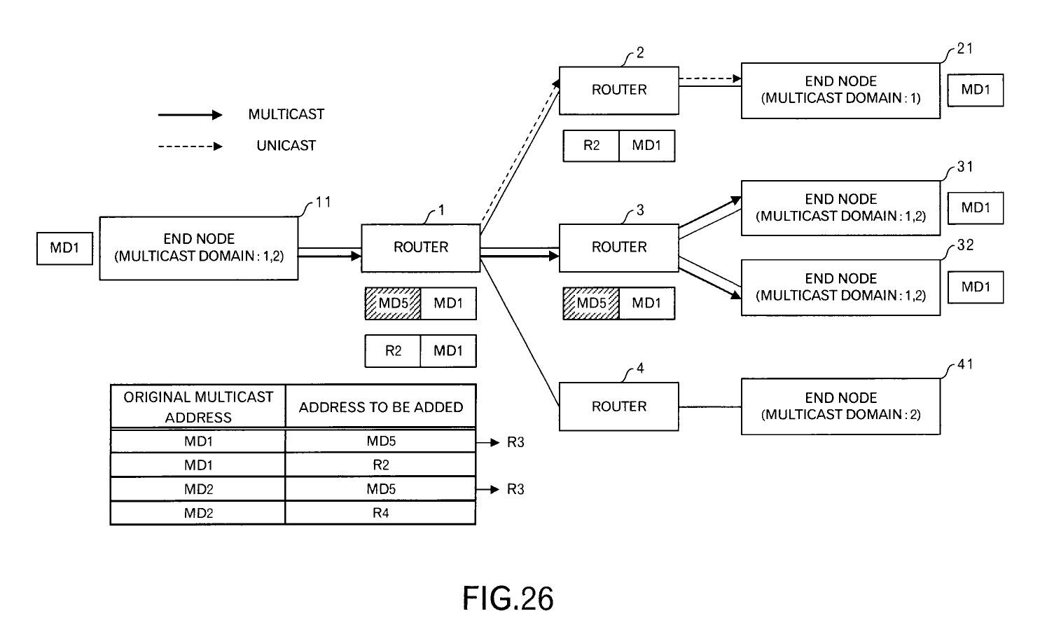

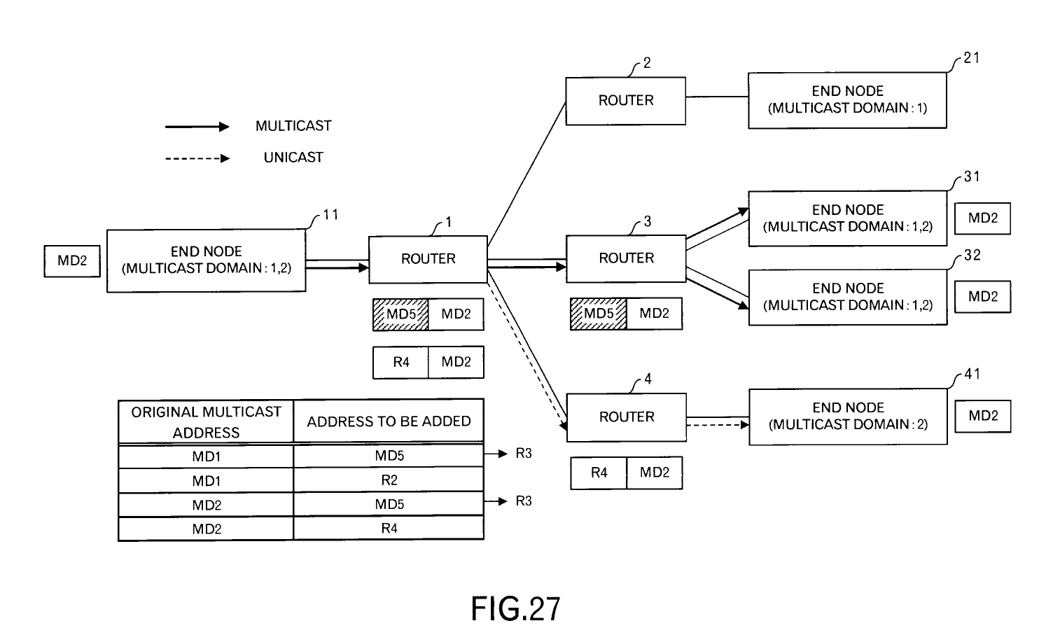

FIGS. 26 and 27 illustrate a packet transfer in case where the inclusion relationship between two multicast domains is the relationship as illustrated in FIG. 18 or 19. FIG. 26 illustrates transfer of a packet including the multicast address “MD1”, and FIG. 27 illustrates transfer of a packet including the multicast address “MD2”. The common end nodes of the multicast domains 1 and 2 are end nodes 11, 31 and 32. The router 1 is connected to the end node 11 that belongs to the multicast domains 1 and 2. The router 2 is connected to the end node 21 that belongs to the multicast domain 1. The router 3 is connected to the end nodes 31 and 32 that belong to the multicast domains 1 and 2. The router 4 is connected to the end node 41 that belongs to the multicast domain 2.

When the router 1 receives a packet including the multicast address “MD1” from the end node 11, the router 1 generates a packet to which the multicast address “MD5” is added, and transmits the generated packet to the router 3. Moreover, the router 1 generates a packet to which the unicast address “R2” is added, and transmits the generated packet to the router 2. When the router 3 receives the packet to which the multicast address “MD5” is added, the router 3 eliminates the multicast address “MD5” from the received packet, and transmits the packet after the elimination to the end nodes 31 and 32. When the router 2 receives a packet to which the unicast address “R2” is added, the router 2 eliminates the unicast address “R2” from the received packet, and transmits the packet after the elimination to the end node 21.

When the router 1 receives a packet including the multicast address “MD2” from the end node 11, the router 1 generates a packet to which the multicast address “MD5” is added, and transmits the generated packet to the router 3. Moreover, the router 1 generates a packet to which the unicast address “R4” is added to that packet, and transmits the generated packet to the router 4. When the router 3 receives the packet to which the multicast address “MD5” is added, the router 3 eliminates the multicast address “MD5” from the received packet, and transmits the packet after the elimination to the end nodes 31 and 32. When the router 4 receives the packet to which the unicast address “R4” is added, the router 4 eliminates the unicast address “R4” from the received packet, and transmits the packet after the elimination to the end node 41.

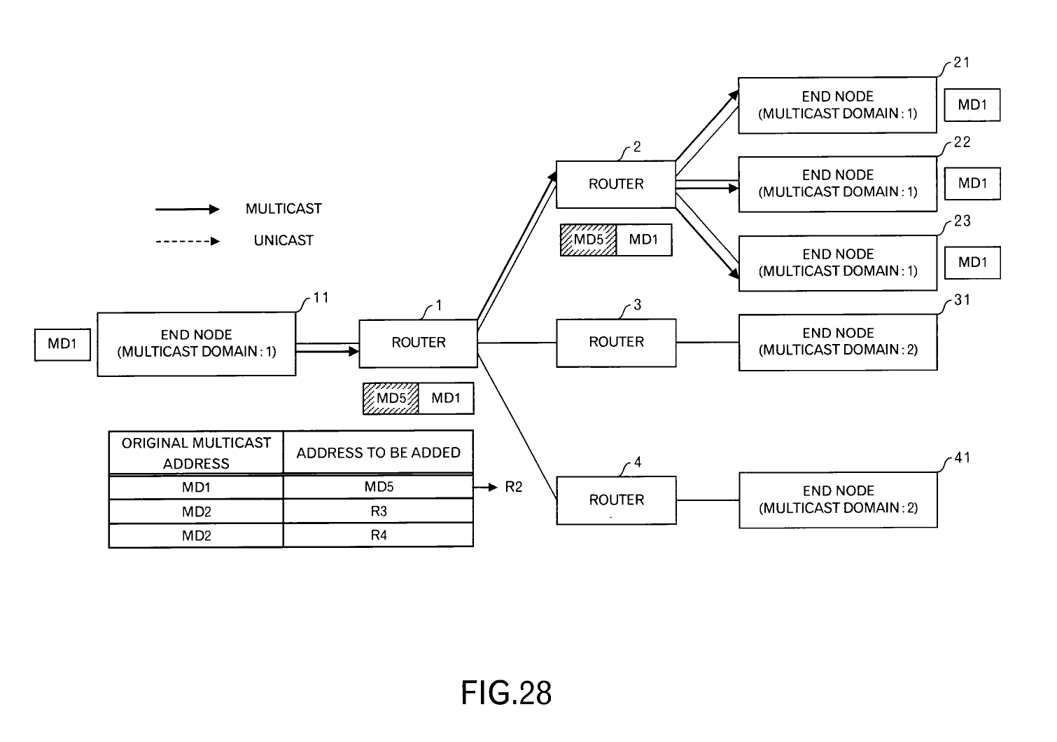

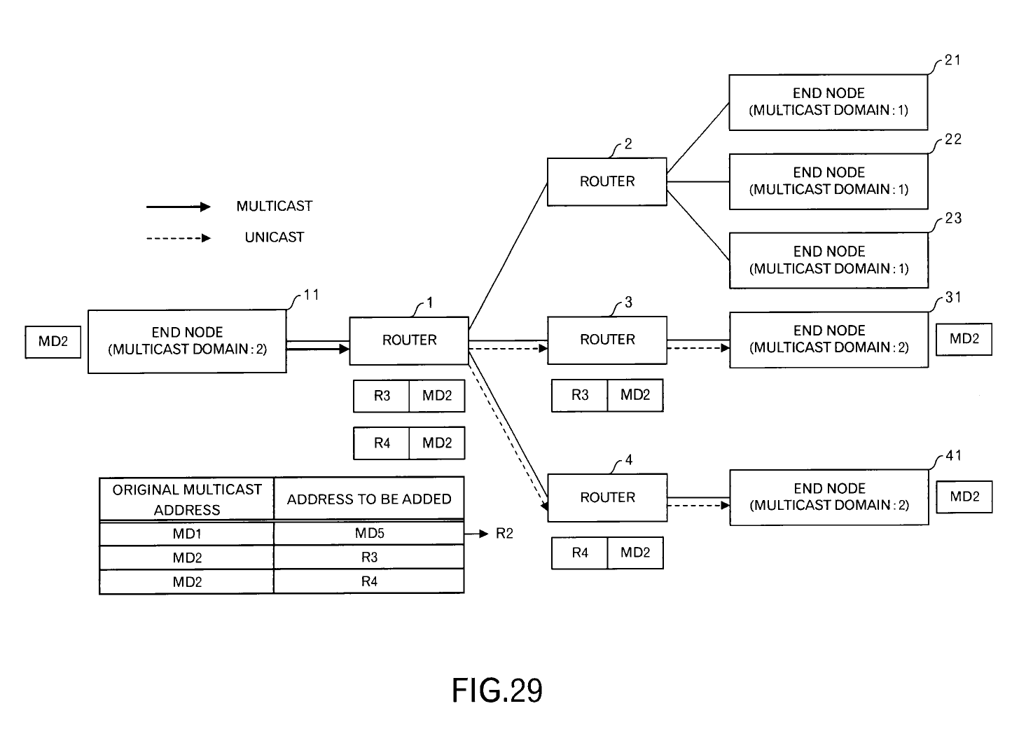

FIGS. 28 and 29 illustrate packet transfer in case where the inclusion relationship between two multicast domains is the relationship as illustrated in FIG. 16 or FIG. 17. FIG. 28 illustrates transfer of a packet including the multicast address “MD1”, and FIG. 29 illustrates transfer of a packet including the multicast address “MD2”. The multicast domain 1 and the multicast domain 2 are completely separated. The router 1 is connected to the end node 11. The router 2 is connected to the end nodes 21 to 23 that belong to the multicast domain 1. The router 3 is connected to the end node 31 that belongs to the multicast domain 2. The router 4 is connected to the end node 41 that belongs to the multicast domain 2.

When the router 1 receives a packet including the multicast address “MD1” from the end node 11, the router 1 generates a packet to which the multicast address “MD5” is added, and transmits the generated packet to the router 2. When the router 2 receives a packet to which the multicast address “MD5” is added, the router 2 eliminates the multicast address “MD5” from the received packet, and transmits the packet after the elimination to the end nodes 21 to 23.

When the router 1 receives a packet including the multicast address “MD2” from the end node 11, the router 1 generates a packet to which the unicast address “R3” is added, and transmits the generated packet to the router 3. Moreover, the router 1 generates a packet to which the unicast address “R4” is added, and transmits the generated packet to the router 4. When the router 3 receives the packet to which the unicast address “R3” is added, the router 3 eliminates the unicast address “R3”, and transmits the packet after the elimination to the end node 31. When the router 4 receives the packet to which the unicast address “R4” is added, the router 4 eliminates the unicast address “R4”, and transmits the packet after the elimination to the end node 41.

By carrying out the aforementioned processing, even when the number of multicast domains is decreased by “1”, it is possible to transmit the packet to the destination.

Although the embodiments of this invention were explained above, this invention is not limited to the embodiments. For example, the functional block configurations of the aforementioned topology management apparatus 10 and the routers 1 to 4 do not always correspond to program module configurations.

Moreover, configurations of the aforementioned tables are mere examples, and may be changed appropriately. Furthermore, as for the processing flows, as long as the processing results do not change, the turns of steps may be exchanged or plural steps may be executed in parallel.

Moreover, the routers 1 to 4 may be virtual routers. Furthermore, instead of the routers, the physical switch or virtual switch may be employed.

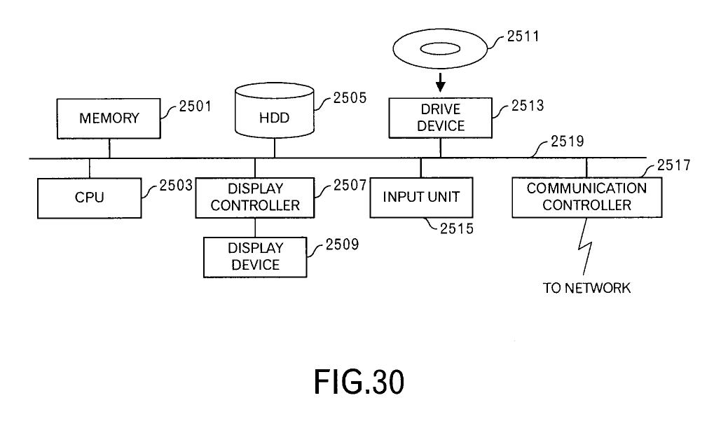

In addition, the topology management apparatus 10 is a computer device as shown in FIG. 30. That is, a memory 2501 (storage device), a CPU 2503 (processor), a hard disk drive (HDD) 2505, a display controller 2507 connected to a display device 2509, a drive device 2513 for a removable disk 2511, an input device 2515, and a communication controller 2517 for connection with a network are connected through a bus 2519 as illustrated in FIG. 30. An operating system (OS) and an application program for carrying out the foregoing processing in the embodiment, are stored in the HDD 2505, and when executed by the CPU 2503, they are read out from the HDD 2505 to the memory 2501. As the need arises, the CPU 2503 controls the display controller 2507, the communication controller 2517, and the drive device 2513, and causes them to perform predetermined operations. Moreover, intermediate processing data is stored in the memory 2501, and if necessary, it is stored in the HDD 2505. In this embodiment of this technique, the application program to realize the aforementioned functions is stored in the computer-readable, non-transitory removable disk 2511 and distributed, and then it is installed into the HDD 2505 from the drive device 2513. It may be installed into the HDD 2505 via the network such as the Internet and the communication controller 2517. In the computer as stated above, the hardware such as the CPU 2503 and the memory 2501, the OS and the application programs systematically cooperate with each other, so that various functions as described above in details are realized.

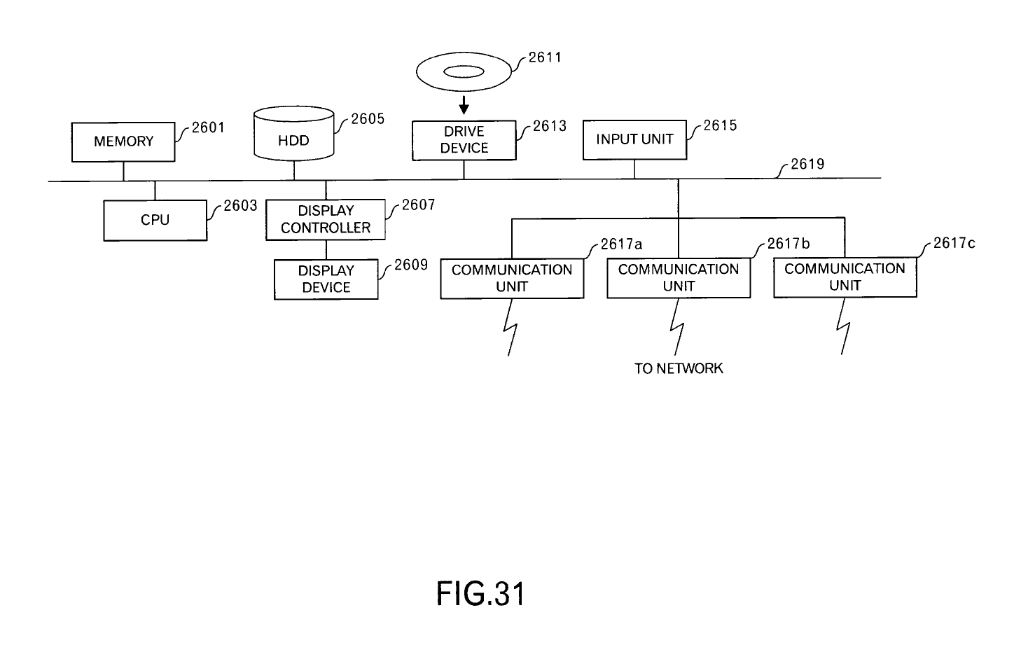

In addition, the aforementioned routers 1 to 4, are computer apparatuses as illustrated in FIG. 31, a memory 2601, CPU 2603, Hard Disk Drive (HDD) 2605, display controller 2607 to be coupled with a display device 2609, drive device 2613 for a removable disk 2611, input device 2615 and communication units 2617 (2617a to 2617c in FIG. 31) for coupling to a network may be coupled with a bus 2619. Incidentally, according to circumstances, the display controller 2607, display device 2609, drive device 2613 and input device 2615 may not be included. The OS and application programs for carrying out a processing in these embodiments are stored in the HDD 2605, and read out from the HDD 2605 to the memory 2601 when being executed by the CPU 2603. If necessary, the CPU 2603 controls the display controller 2607, communication unit 2617 and drive device 2613 to carry out necessary operations. Incidentally, data that was inputted through any one of the communication units 2617 is outputted through another communication unit 2617. The CPU 2603 controls the communication units 2617 to appropriately switch output destinations. In addition, data during the processing is stored in the memory 2601, and stored in the HDD 2605 if necessary. In the embodiments of this technique, the application programs for carrying out the aforementioned processing are distributed by a computer-readable removable disk 2611 storing the application programs, and the application programs are installed into the HDD 2605 through the drive device 2613. The programs may be installed into the HDD 2605 through the communication unit 2617 and the network such as the Internet. Such a computer apparatus realizes the aforementioned various functions by cooperating the hardware such as the CPU 2603, memory 2601 and the like with the OS and the application programs if necessary.

The aforementioned embodiments are outlined as follows:

A network management method relating to the embodiments includes: (A) upon detecting that the number of multicast domains in a network exceeds a predetermined threshold, setting one new multicast domain for at least apart of plural multicast domains based on an inclusion relationship among the plural multicast domains; and (B) transmitting to a relay apparatus, data representing correspondence between a multicast address of the plural multicast domains and a multicast address of the one new multicast domain.

According to this configuration, in the network in which the number of multicast addresses that can be used is limited, it becomes possible to prevent from exhausting the multicast addresses and reduce the communication load on the network.

Moreover, the aforementioned management method may further include: (C) identifying a node that does not belong to the one new multicast domain from among nodes that belongs to either of the plural multicast domains; and (D) transmitting to the relay apparatus in the network, data representing correspondence between a unicast address of a certain relay apparatus that has the identified node under the certain relay apparatus and a multicast address of the plural multicast domains. Thus, it becomes possible to transmit data by the unicast to nodes to which data cannot be sent by the multicast.

Moreover, the aforementioned setting may include: (a1) setting the one new multicast domain so that the number of nodes that belong to the one new multicast domain is the greatest. According to this configuration, because data can be transmitted by the multicast to node as many as possible, it becomes possible to appropriately suppress the increase of the communication load on the network.

Furthermore, the aforementioned management method may include (E) collecting, from the relay apparatus in the network, a multicast address of a multicast domain relating to the relay apparatus; (F) counting the number of multicast domains in the network based on the collected multicast address; and (G) determining whether or not the counted number of multicast domains exceeds the predetermined threshold. By doing so, it becomes possible to efficiently collect information by using IGMP, PIM or the like for example.

Incidentally, it is possible to create a program causing a computer to execute the aforementioned processing, and such a program is stored in a computer readable storage medium or storage device such as a flexible disk, CD-ROM, DVD-ROM, magneto-optic disk, a semiconductor memory, and hard disk. In addition, the intermediate processing result is temporarily stored in a storage device such as a main memory or the like.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A computer-readable, non-transitory storage medium storing a program for causing a computer to execute a process, the process comprising:
upon detecting that the number of multicast domains in a network exceeds a predetermined threshold, setting one new multicast domain for at least a part of a plurality of multicast domains based on an inclusion relationship among the plurality of multicast domains; and
transmitting to a relay apparatus, data representing correspondence between a multicast address of the plurality of multicast domains and a multicast address of the one new multicast domain.

2. The computer-readable, non-transitory storage medium as set forth in claim 1, wherein the process comprises:
identifying a node that does not belong to the one new multicast domain from among nodes that belongs to either of the plurality of multicast domains; and
transmitting to the relay apparatus in the network, data representing correspondence between a unicast address of a certain relay apparatus that has the identified node under the certain relay apparatus and a multicast address of the plurality of multicast domains.

3. The computer-readable, non-transitory storage medium as set forth in claim 1, wherein the setting comprises:
setting the one new multicast domain so that the number of nodes that belong to the one new multicast domain is the greatest.

4. The computer-readable, non-transitory storage medium as set forth in claim 1, wherein the process further comprises:
collecting, from the relay apparatus in the network, a multicast address of a multicast domain relating to the relay apparatus;
counting the number of multicast domains in the network based on the collected multicast address; and
determining whether or not the counted number of multicast domains exceeds the predetermined threshold.

5. A network management method, comprising:
upon detecting that the number of multicast domains in a network exceeds a predetermined threshold, setting, by using a computer, one new multicast domain for at least a part of a plurality of multicast domains based on an inclusion relationship among the plurality of multicast domains; and
transmitting, by using the computer, to a relay apparatus, data representing correspondence between a multicast address of the plurality of multicast domains and a multicast address of the one new multicast domain.

6. A network management apparatus, comprising:
a memory; and
a processor configured to use the memory and execute a process, the processing comprising:
upon detecting that the number of multicast domains in a network exceeds a predetermined threshold, setting one new multicast domain for at least a part of a plurality of multicast domains based on an inclusion relationship among the plurality of multicast domains; and
transmitting to a relay apparatus, data representing correspondence between a multicast address of the plurality of multicast domains and a multicast address of the one new multicast domain.
